(19) United States
(12) Patent Application Publication
(10) Pub. No.: US 2025/0139874 A1
(43) Pub. Date: May 1, 2025

(54) LEARNING METHOD, INFORMATION PROCESSING DEVICE, AND RECORDING MEDIUM

(71) Applicant: Sony Group Corporation, Tokyo (JP)

(72) Inventor: Kazunori KAMIO, Kanagawa (JP)

(73) Assignee: Sony Group Corporation, Tokyo (JP)

(21) Appl. No.: 18/835,021

(22) PCT Filed: Feb. 20, 2023
(86) PCT No.: PCT/JP2023/005920

§ 371 Date: Aug. 1, 2024

(30) Foreign Application Priority Data
Mar. 11, 2022 (JP) 2022-038305

(51) Int. Cl. G06T 15/20; G06T 7/55; G06T 15/06

(52) U.S. Cl. CPC G06T 15/20; G06T 7/55; G06T 15/06; G06T 2200/24; G06T 2207/10028; G06T 2207/20081; G06T 2207/20084

(57) ABSTRACT

There is provided a learning method, an information processing device, and a recording medium that can achieve high-speed learning by a neural network. The information processing device renders a plurality of depth images based on a plurality of different viewpoints from low-precision three-dimensional data, and performs learning processing of a neural network that generates high-precision three-dimensional data from a two-dimensional image, based on the plurality of depth images. The present disclosure can be applied, for example, to a technology for creating 3D assets for large-scale outdoor video production.

### TECHNICAL FIELD

The present disclosure relates to a learning method, an information processing device, and a recording medium, and more particularly to a learning method, an information processing device, and a recording medium that can achieve high-speed learning by a neural network.

### BACKGROUND ART

Hitherto, the quality of 3D map data is being improved in line with advances in car navigation systems and autonomous driving technologies. PTL 1 discloses a technology in which matching of a surrounding reference map with observation information of the real world is performed and a map corresponding to an inconsistent part is updated.

Incidentally, in the production of 3DCG video, it takes an enormous amount of time to create 3D assets for large-scale outdoor video production, but the three-dimensional map data as described above is not of a quality sufficient for use in video products.

In response to this, in recent years, it has become possible to create high-quality images from any viewpoint, such as 3D assets for video production, from images from a plurality of viewpoints through learning using a neural network.

### CITATION LIST

### Patent Literature

### PTL 1:

JP 2017-181870A

### SUMMARY

### Technical Problem

However, learning using a neural network based only on images takes a long time to converge.

The present disclosure has been made in view of such circumstances, and aims at making it possible to achieve high-speed learning using a neural network.

### Solution to Problem

A learning method according to the present disclosure is a learning method including: by an information processing device, rendering a plurality of depth images based on a plurality of different viewpoints from low-precision three-dimensional data; and performing learning processing of a neural network that generates high-precision three-dimensional data from a two-dimensional image, based on the plurality of depth images.

An information processing device according to the present disclosure is an information processing device including: a rendering unit that renders a plurality of depth images based on a plurality of different viewpoints from low-precision three-dimensional data; and a learning processing unit that performs learning processing of a neural network that generates high precision three-dimensional data from a two-dimensional image, based on the plurality of depth images.

A recording medium according to the present disclosure is a computer-readable recording medium having recorded thereon a program for executing processing of rendering a plurality of depth images based on a plurality of different viewpoints from low-precision three-dimensional data; and performing learning processing of a neural network that generates high precision three-dimensional data from a two-dimensional image, based on the plurality of depth images.

In the present disclosure, a plurality of depth images based on a plurality of different viewpoints from low-precision three-dimensional data are rendered; and learning processing of a neural network that generates high precision three-dimensional data from a two-dimensional image is performed on the basis of the plurality of depth images.

### BRIEF DESCRIPTION OF DRAWINGS

FIG. 1 is a block diagram illustrating a functional configuration example of an information processing device according to the present disclosure.

FIG. 2 is a diagram illustrating an overview of functions of the information processing device.

FIG. 3 is a flowchart illustrating an overview of an operation of the information processing device.

FIG. 4 is a flowchart illustrating details of learning processing.

FIG. 5 is a diagram illustrating an overview of an NeRF.

FIG. 6 is a diagram illustrating an improved NeRF using a depth image.

FIG. 7 illustrates an example of an inference result of a depth image.

FIG. 8 illustrates an example of an inference result of a two-dimensional image.

FIG. 9 is a flowchart illustrating details of fine tuning.

FIG. 10 is a diagram illustrating an example of updating DNN coefficients by fine tuning.

FIG. 11 is a block diagram illustrating a configuration example of a computer.

### DESCRIPTION OF EMBODIMENTS

Hereinafter, modes for carrying out the present disclosure (hereinafter referred to as embodiments) will be described. The description will be made in the following order.
1. Problems in Conventional Technologies
2. Overview of Information Processing Device According to Present Disclosure
3. Learning Processing Using 3D Map Data
4. Fine-tuning Using Latest Image
5. Configuration Example of Computer

### 1. Problems in Conventional Technologies

The conventional production of 3DCG (three-dimensional computer graphics) video takes an enormous amount of time to create 3D assets (assets for 3DCG production) for large-scale outdoor video production. Meanwhile, although there is generally 3D map data, it does not have a quality suitable for use in video productions.

The reasons for this include, first, the fact that image capture work is difficult and the CG has to be manually created, which takes a lot of time. Secondly, in recent years, there has been an increased need for assets for 3DCG production, and CG has become closer to realistic depictions like photographs. Another reason is that 3D map data is not easily available.

In response to this, in recent years, it has become possible to create high-quality images from any viewpoint, such as assets for assets for 3DCG production, from images from a plurality of viewpoints through learning using a neural network. However, using this technique for large-scale outdoor video production still requires a lot of image capture, and therefore, the time required for image capture work remains a problem. In particular, learning using a neural network based only on images takes a long time to converge, and therefore, it is distant to use the above technique to create assets for large-scale outdoor 3DCG production.

Therefore, in the technology according to the present disclosure, high-speed learning is achieved by performing learning processing of a neural network that generates high precision three-dimensional data using multi-view two-dimensional images and depth images rendered from low-precision three-dimensional data. In addition, in the technology according to the present disclosure, high-quality three-dimensional representation is achieved by fine-tuning the neural network by using an actually captured image of a real object corresponding to the high-precision three-dimensional data.

### 2. Overview of Information Processing Device According to Present Disclosure

### (Functional Configuration Example of Information Processing Device)

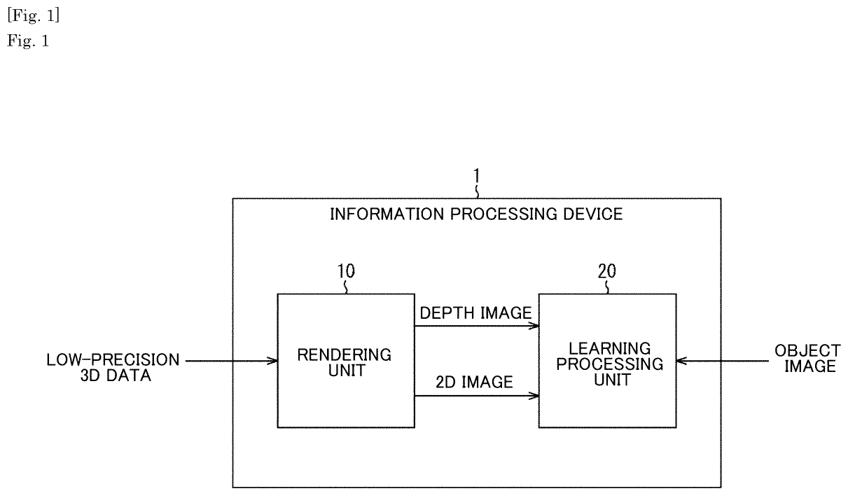

FIG. 1 is a block diagram illustrating a functional configuration example of an information processing device according to the present disclosure.

The information processing device 1 in FIG. 1 is configured as, for example, a computer that operates by executing a predetermined program. The information processing device 1 implements, as functional blocks, a rendering unit 10 and a learning processing unit 20. The rendering unit 10 and the learning processing unit 20 may be implemented by information processing devices (computers) that are configured separately.

The rendering unit 10 renders a plurality of two-dimensional images (2D images) based on a plurality of different viewpoints from low-precision three-dimensional data (low-precision 3D data). The 2D image is an RGB image as with an image captured by a typical camera. The rendering unit 10 also renders a plurality of depth images based on a plurality of different viewpoints from the low-precision 3D data. The depth image is two-dimensional data having depth information (distance information) as pixel information of each pixel of the 2D image.

The low-precision 3D data is data of an object having information on length, width, and height, and is also low-precision data that can represent the general shape of the object. The object may be a moving object such as a car or an airplane, a construction such as a house, a building, a station, or an airport, a structure such as a road, a bridge, or a tunnel, or an entire city including these.

In the following description, the 3D low-precision data will be described as three-dimensional map data that can represent each city in its entirety.

The learning processing unit 20 performs, based on a plurality of depth images and a plurality of 2D images rendered by the rendering unit 10, learning processing of a neural network that generates high-precision three-dimensional data (high-precision 3D data) corresponding to low-precision 3D data from a two-dimensional image from any viewpoint. Specifically, the learning processing unit 20 performs learning processing to learn three-dimensional representation by the neural network.

Unlike the low-precision 3D data, the high precision 3D data is high precision data that can represent an object with high definition.

The learning processing unit 20 also fine-tunes the three-dimensional representation based on the neural network, by using an actually captured object image of a real object corresponding to the generated high-precision 3D data.

### (Overview of Functions and Operation of Information Processing Device)

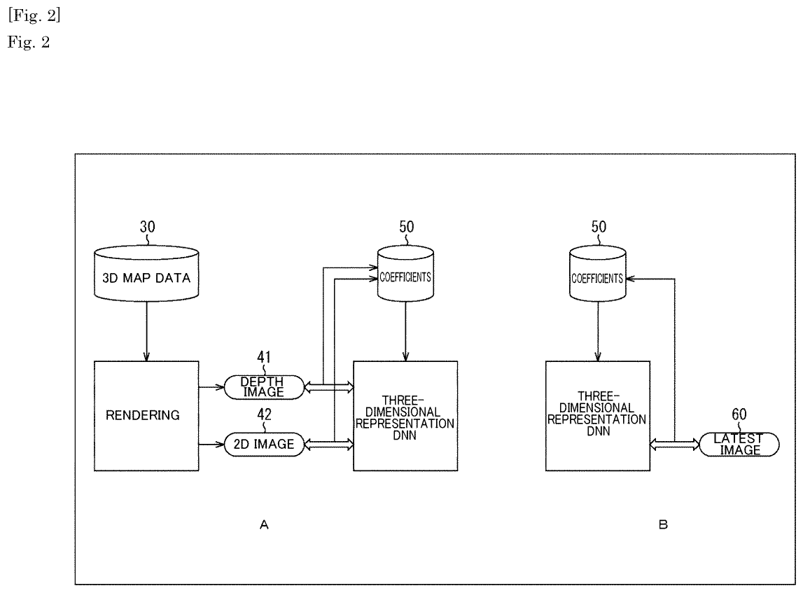

FIG. 2 is a diagram illustrating an overview of functions of the information processing device 1 in FIG. 1.

In FIG. 2, diagram A is a conceptual diagram of the function of the information processing device 1 that performs learning processing using three-dimensional map data (3D map data).

The information processing device 1 renders, from the 3D map data, a depth image 41 and a two-dimensional image 42 that are both based on a viewpoint specified by a user. Then, the information processing device 1 acquires, based on the depth image 41 and the two-dimensional image 42, DNN coefficients 50 by learning a deep neural network that can provide three-dimensional representation (three-dimensional representation DNN).

In FIG. 2, diagram B is a conceptual diagram of the function of the information processing device 1 that fine-tunes a learned neural network by using an actually captured image.

The information processing device 1 acquires a latest image 60 captured from a viewpoint specified by the user in a real space corresponding to the 3D map data. Then, the information processing device 1 updates the DNN coefficients 50 by fine-tuning the three-dimensional representation DNN by using the latest image 60.

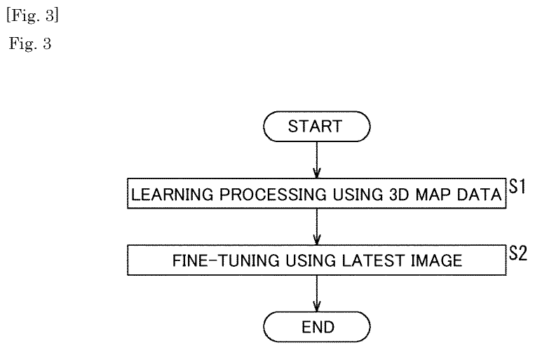

FIG. 3 is a diagram illustrating an overview of an operation of the information processing device 1 in FIG. 1.

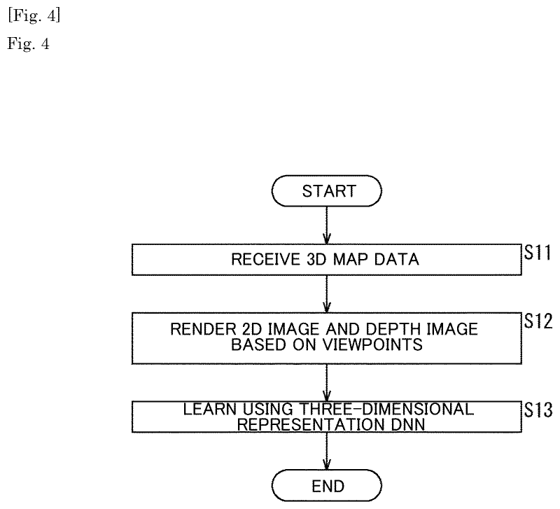

In step S1, the information processing device 1 performs learning processing using the 3D map data, as described with reference to diagram A of FIG. 2. The learning processing in step S1 can be repeated for each viewpoint specified by the user. Details of the learning processing will be described later with reference to the flowchart of FIG. 4.

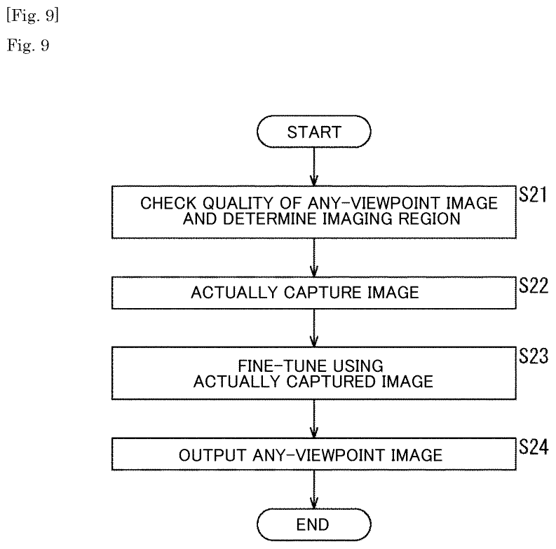

In step S2, the information processing device 1 fine-tunes the neural network using the latest image, as described with reference to diagram B of FIG. 2. The fine-tuning in step S2 can also be repeated for each viewpoint specified by the user, and details of the fine-tuning will be described later with reference to a flowchart of FIG. 9.

In the following description, details of each operation of the information processing device 1 will be described.

### 3. Learning Processing Using 3D Map Data

First, details of the learning processing using 3D map data by the information processing device 1 will be described with reference to a flowchart of FIG. 4.

In step S11, the information processing device 1 receives 3D map data.

As described above, creating assets for large-scale outdoor 3DCG production requires a large amount of image capture work, while in recent years, 3D map data has become easily available as public data on the Internet. This makes it possible to obtain rough shape and information of outdoor regions from several months or even several years ago without having to actually go outdoors to capture images.

In step S12, the rendering unit 10 of the information processing device 1 renders, from the received 3D map data, a 2D image and a depth image that are both based on a plurality of viewpoints. Here, a viewpoint from which a region where assets for 3DCG production to be used in outdoor video production is to be created is viewed (i.e., the viewpoint specified by the user) is a reference viewpoint.

In this way, by obtaining a 2D image of two-dimensional data (2D data) from three-dimensional data, an image in the same format as that in the actual image capture work can be obtained. Since 2D data is easier to handle and data sets are easier to collect than 3D data, tools that can handle 2D data and neural networks that perform learning using 2D data can be widely used.

In step S13, the learning processing unit 20 performs learning using a three-dimensional representation DNN, based on the 2D image and the depth image that are both based on the plurality of viewpoints obtained by rendering.

The assets used for 3DCG production to be used in video production require higher video quality than 3D map data used in car navigation systems and the like. Accordingly, a neural network may be used that can provide three-dimensional representation, for example, a neural network that learns an implicit function representation that can represent a figure having any resolution with a relatively small number of coefficients as a three-dimensional representation. The technique proposed in “Nerf: Representing Scenes as Neural Radiance Fields for View Synthesis” (hereinafter referred to as an NeRF) is used herein.

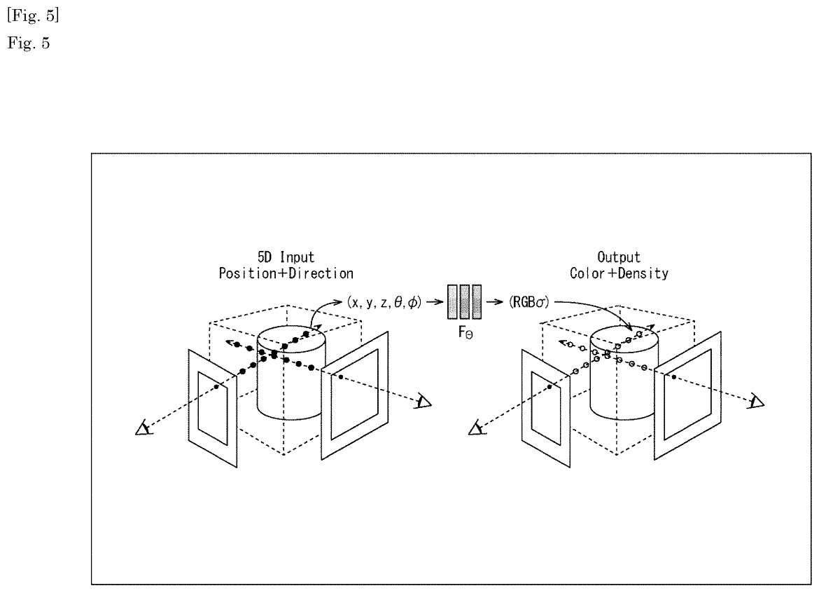

An overview of an NeRF will now be described with reference to FIG. 5.

The NeRF is a technique of learning Radiance Fields (color RGB and its density σ), which are vector fields corresponding to five dimensions (position x, y, z and direction θ, φ) of a target space, by using a neural network F_{θ}.

In the NeRF, a single color is obtained by integrating the Radiance Fields output by the neural network F_{θ} for points on a ray of light corresponding to a viewing direction. By performing this operation for all pixels, a single image is generated (volume rendering). By updating Fe so that the generated image matches the actual image, the rendering result approaches the actual image, and as a result, F_{θ} becomes a three-dimensional spatial representation (Radiance Fields).

By using color c of each coordinate in space, the rendering result can be represented as a color C as seen from the focus (viewpoint) of a ray of light r by the following Equations (1) and (2).

$$\begin{matrix}[ Math . 1 ] & \\ \hat{C} = {\int }_{{t}_{n}}^{{t}_{f}} T ( t ) σ ( t ) c ( t ) dt & ( 1 )\end{matrix}$$

$$\begin{matrix}[ Math . 2 ] & \\ where T ( t ) = exp ( - {\int }_{{t}_{n}}^{t} σ ( r ( s ) ) ds ) & ( 2 )\end{matrix}$$

In Equations (1) and (2), t is a distance from the focal point, and tₙ and t_{f} are lower and upper limits of the distance to be considered in rendering. T(t) represents the situation in which light traveling from a certain point to the focal point is blocked by a point present in front of it (on the focal point side). If there is a point having a high density in r(s) (tₙ<<t), T (t) approaches 0, and the light emitted from r(t) no longer affects C.

In this way, volume rendering can be performed by integrating the product of the color c and the density σ on a ray of light.

The density σ in the Radiance Fields is also an index (probability of existence) indicating the presence of an object. Therefore, as represented in the following Equation (3), a depth D can be obtained by integrating, on the ray of light, the density σ of the object corresponding to the viewpoint.

$$\begin{matrix}[ Math . 3 ] & \\ \hat{D} ( r ) = {\int }_{{t}_{n}}^{{t}_{t}} T ( t ) σ ( t ) tdt & ( 3 )\end{matrix}$$

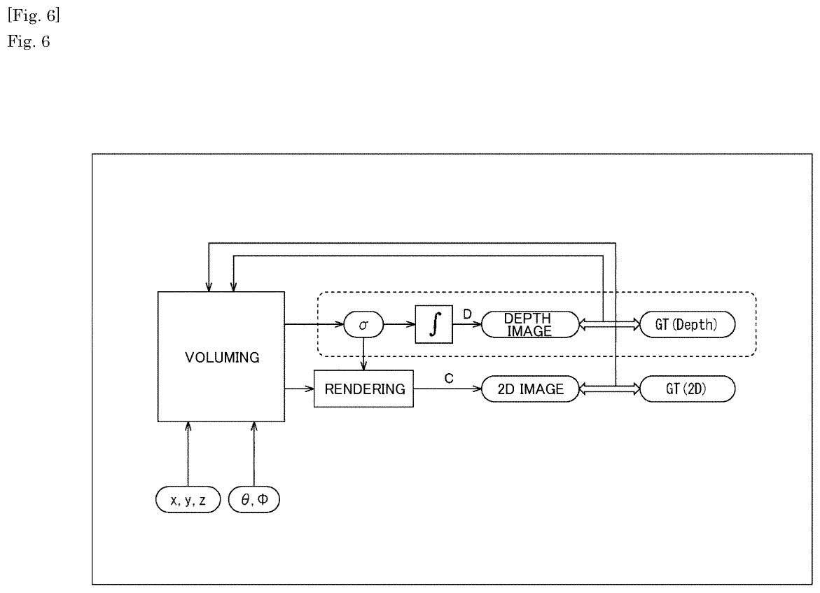

FIG. 6 is a diagram illustrating an improved NeRF using a depth image by means of the technology according to the present disclosure.

In the conventional NeRF, as illustrated in FIG. 6, an implicit function is learned so as to minimize the error between a 2D image (rendered image), which is obtained by rendering volumetric data for spatial position x, y, z and direction θ, φ corresponding to each viewpoint, and a pre-prepared ground truth (GT) image. In the technology according to the present disclosure, the GT image is a 2D image rendered from 3D map data.

Furthermore, in the NeRF improved by means of the technology according to the present disclosure, an implicit function is learned so as to minimize the error between an integral value (depth image) of the density (probability of existence) σ of an object corresponding to each viewpoint and a pre-prepared GT image, as surrounded by a dashed line in FIG. 6. In the technology according to the present disclosure, the GT image is a depth image rendered from 3D map data.

As described above, learning using a neural network based only on images as in the conventional NeRF takes a long time to converge, and therefore, it is distant to use this technique to create assets for large-scale outdoor 3DCG production. In particular, roads with many flat areas and building walls are factors that cause the learning to take a long time to converge.

On the other hand, according to the above processing, not only a 2D image but also a depth image is rendered from 3D map data, and the improved NeRF performs learning processing using not only the 2D image but also the depth image. This makes it possible to significantly improve the learning speed, and to achieve high-speed learning using a neural network.

Therefore, it is possible to create assets for large-scale outdoor 3DCG production in a short period of time as high-precision 3D data. In addition, by using 3D map data to learn a neural network, assets for 3DCG production can be created without having to spend time on image capture work, such as going outdoors to capture images.

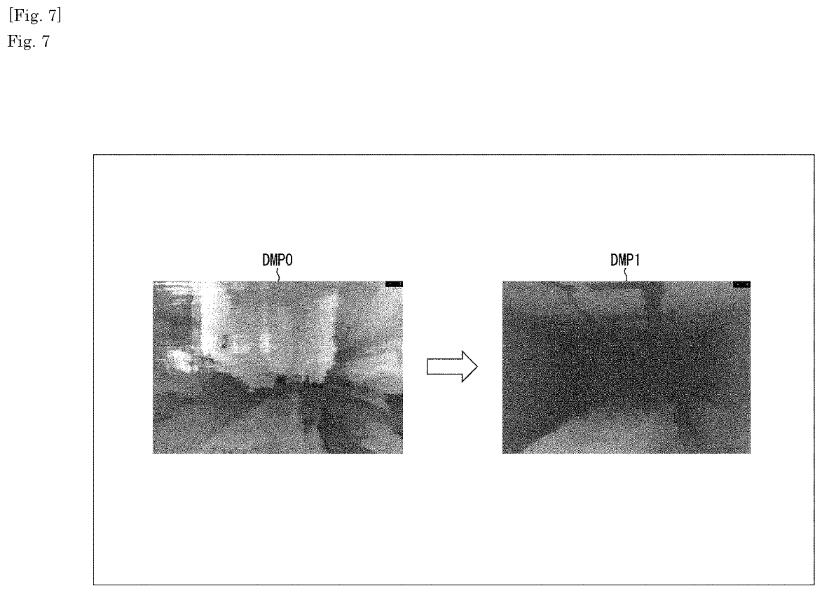

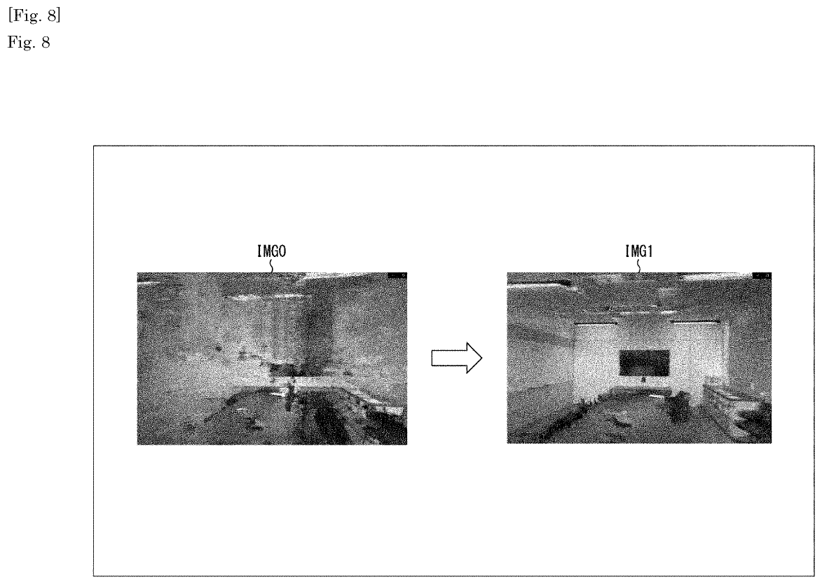

Advantageous effects of the improved NeRF will be described with reference to FIGS. 7 and 8. It is assumed herein that an image from a viewpoint from which a room with depth is viewed can be obtained by inference using coefficients learned by an NeRF.

On the left side of FIG. 7, an inference result DMP0 of a depth image using coefficients learned by the conventional NeRF is illustrated, and on the right side of FIG. 7, an inference result DMP1 of the depth image using coefficients learned by the improved NeRF is illustrated.

As illustrated by the inference result DMP0, the conventional NeRF is unable to properly infer the ceiling and back wall of the room (a white area from the center upwards), and poor performance in flat areas can be seen. On the other hand, as indicated by the inference result DMP1, the improved NeRF makes it possible to output a high-performance depth image that is appropriately inferred for the ceiling and back wall of the room.

On the left side of FIG. 8, an inference result IMG0 of a two-dimensional image (RGB image) using coefficients learned by the conventional NeRF is illustrated, and on the right side of FIG. 8, an inference result IMG1 of the two-dimensional image using coefficients learned by the improved NeRF is illustrated.

As described above, according to the conventional NeRF, the depth image has poor performance, and therefore, only a low-quality two-dimensional image such as the inference result IMG0 are obtained. On the other hand, according to the improved NeRF, a high-performance depth image is obtained, making it possible to obtain a two-dimensional image that has a quality high enough to check the conditions of the room, such as the inference result IMG1.

### 4. Fine-tuning Using Latest Image

Next, details of fine-tuning of a neural network using the latest image by the information processing device 1 will be described with reference to the flowchart of FIG. 9.

In step S21, the user checks, by quantitative numerical error and qualitative visual evaluation, the quality of an any-viewpoint image output using the neural network of three-dimensional representation learned by the above-described learning processing. As a result, the user determines, as an imaging region, a region that does not meet the quality requirements for assets for 3DCG production. The quality of the any-viewpoint image may be evaluated by the information processing device 1 based on a peak signal to noise ratio (PSNR).

In step S22, based on the determined imaging region, the user goes to the corresponding outdoor location and actually captures images. Specifically, the user focuses on capturing the locations corresponding to the viewpoints of the images with low quality among any-viewpoint images.

In step S23, the learning processing unit 20 of the information processing device 1 performs fine-tuning of the neural network for three-dimensional representation by using an actually captured image (latest image).

In step S24, the learning processing unit 20 again outputs an any-viewpoint image by using the fine-tuned neural network for three-dimensional representation.

The above-described fine-tuning is repeated for each viewpoint specified by the user, for example, as long as higher quality is required as the quality of the image from any viewpoint. In other words, the any viewpoint image may be a 2D image for a viewpoint specified by the user.

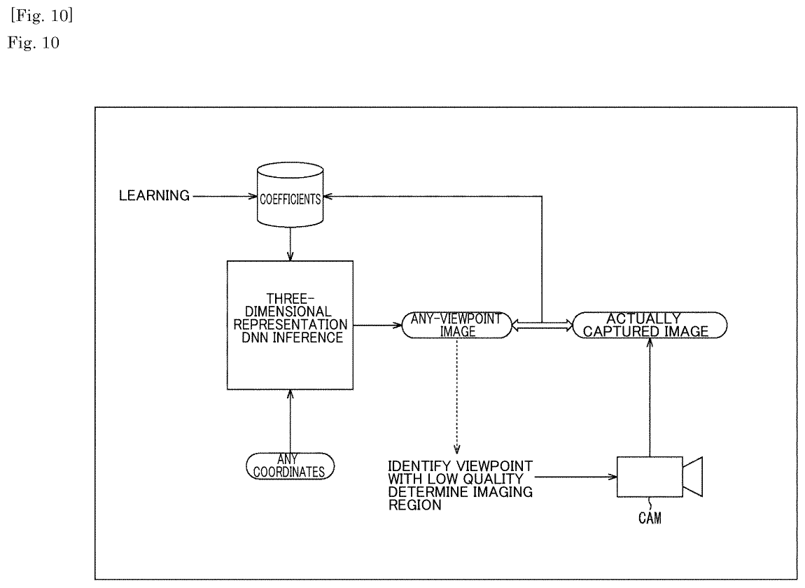

FIG. 10 is a diagram illustrating an example of updating the DNN coefficients by fine-tuning the three-dimensional representation DNN in the information processing device 1.

In the above-described learning processing, a 2D image and a depth image from a viewpoint (coordinates) according to camera work used in the video production, which is specified by the user, are rendered from 3D map data, and a three-dimensional representation DNN is learned to obtain DNN coefficients. The coordinates according to the camera work are specified by the latitude, longitude, and height in the 3D map data, and the direction of the camera.

As illustrated in FIG. 10, the information processing device 1 can obtain an image at any coordinates (any-viewpoint image) by inference using the DNN coefficients obtained by learning (three-dimensional representation DNN inference).

The user checks the quality of each of the obtained any-viewpoint images, and identifies a viewpoint(s) (any-viewpoint image(s)) with low quality. The user determines an imaging region(s) corresponding to the identified viewpoint(s), and actually captures an image(s) with the camera CAM at a location(s) corresponding to the imaging region(s).

The information processing device 1 can update the DNN coefficients by fine-tuning the three-dimensional representation DNN, based on the error between the image actually captured by the camera CAM and the inference result (any-viewpoint image) of the three-dimensional representation DNN inference based on 3D map data.

According to the above processing, the three-dimensional representation based on the neural network can be fine-tuned by using an actually captured image, thereby making it possible to provide high-quality three-dimensional representation. In particular, desired images are output by the neural network in line with the camera work actually used in video production, and their quality is checked; if higher quality is required, the quality can be improved by focusing on fine-tuning images around the camera work. Furthermore, by feeding back the improved quality image to the 3D map data, it is possible to update the 3D map data.

### 5. Configuration Example of Computer

The above-described series of processing can also be executed by hardware or software. In a case where the series of processing is executed by software, a program that constitutes the software is installed on a computer. In this case, the computer includes, for example, a computer built into dedicated hardware and a general-purpose personal computer in which various programs are installed to enable the personal computer to execute various types of functions.

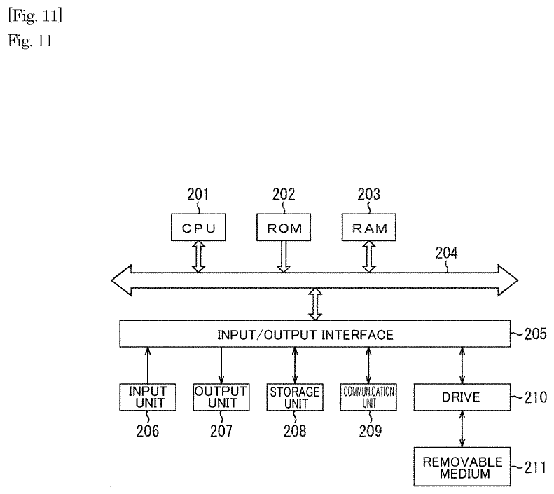

FIG. 11 is a block diagram illustrating a configuration example of computer hardware that performs the above-described series of processing using a program.

In the computer, a CPU 201, a read-only memory (ROM) 202, and a random access memory (RAM) 203 are connected to one another via a bus 204.

An input/output interface 205 is further connected to the bus 204. An input unit 206, an output unit 207, a storage unit 208, a communication unit 209, and a drive 210 are connected to the input/output interface 205.

Examples of the input unit 206 include a keyboard, a mouse, and a microphone. Examples of the output unit 207 include a display and a speaker. Examples of the storage unit 208 include a hard disk and non-volatile memory. Examples of the communication unit 209 include a network interface. The drive 210 drives a removable medium 211 such as a magnetic disk, an optical disc, a magneto-optical disk, or semiconductor memory.

In the computer that has the above configuration, for example, the CPU 201 performs the above-described series of processing by loading a program stored in the storage unit 208 to the RAM 203 via the input/output interface 205 and the bus 204 and executing the program.

The program executed by the computer (the CPU 201) can be recorded on, for example, the removable medium 211 serving as a package medium for supply. The program can also be provided via a wired or wireless transmission medium such as a local area network, the Internet, or digital satellite broadcasting.

In the computer, by mounting the removable medium 211 on the drive 210, it is possible to install the program in the storage unit 208 via the input/output interface 205. The program can be received by the communication unit 209 via a wired or wireless transmission medium to be installed in the storage unit 208. In addition, this program may be installed in advance in the ROM 202 or the storage unit 208.

The program executed by a computer may be a program that performs processing chronologically in the order described in the present specification or may be a program that performs processing in parallel or at a necessary timing such as a called time.

Embodiments of the present disclosure are not limited to the above-described embodiments, and various modifications can be made without departing from the essential spirit of the present disclosure.

The advantageous effects described herein are merely exemplary and are not limited, and other advantageous effects may be obtained.

Furthermore, the present disclosure can be configured as follows.

(1)

A learning method performed by an information processing device, the method including:
rendering a plurality of depth images based on a plurality of different viewpoints from low-precision three-dimensional data; and
performing learning processing of a neural network that generates high-precision three-dimensional data from a two-dimensional image, based on the plurality of depth images.
   (2)

The learning method according to (1), wherein the learning processing includes learning a three-dimensional representation by the neural network.

(3)

The learning method according to (2), wherein the three-dimensional representation by the neural network includes implicit function representation.

(4)

The learning method according to (3), wherein the learning processing includes learning Radiance Fields.

(5)

The learning method according to (4), including:
further rendering a plurality of the two-dimensional images based on the plurality of viewpoints from the low-precision three-dimensional data; and
performing the learning processing based on the plurality of depth images and the plurality of two-dimensional images.
   (6)

The learning method according to (5), including: learning an implicit function so as to minimize an error, in the Radiance Fields, between an integral value of density of an object corresponding to the plurality of viewpoints and the plurality of depth images.

(7)

The learning method according to (6), including: learning the implicit function so as to further minimize an error between rendering images corresponding to the plurality of viewpoints obtained by volume rendering using the Radiance Fields and the plurality of two-dimensional images.

(8)

The learning method according to any one of (1) to (7), including: rendering the plurality of depth images from the low-precision three-dimensional data based on a viewpoint specified by a user.

(9)

The learning method according to any one of (1) to (7), including: fine-tuning the neural network by using an object image obtained by capturing a real object corresponding to the high-precision three-dimensional data.

(10)

The learning method according to (9), including: fine-tuning the neural network based on an error between a viewpoint image for any viewpoint obtained by inference using the neural network and the object image corresponding to the viewpoint.

(11)

The learning method according to (10), wherein the viewpoint image is the two-dimensional image for a viewpoint specified by a user.

(12)

The learning method according to (1), wherein the low-precision three-dimensional data includes three-dimensional map data.

(13)

An information processing device including:
a rendering unit that renders a plurality of depth images based on a plurality of different viewpoints from low-precision three-dimensional data; and
a learning processing unit that performs learning processing of a neural network that generates high-precision three-dimensional data from a two-dimensional image, based on the plurality of depth images.
   (14)

A computer-readable recording medium having recorded thereon a program for executing processing of:
rendering a plurality of depth images based on a plurality of different viewpoints from low-precision three-dimensional data; and
performing learning processing of a neural network that generates high-precision three-dimensional data from a two-dimensional image, based on the plurality of depth images.

### REFERENCE SIGNS LIST

1 Information processing device
10 Rendering unit
20 Learning processing unit
30 Three-dimensional map data
41 Depth image
42 Two-dimensional image
50 DNN coefficients
60 Latest image

1. A learning method performed by an information processing device, the method comprising:
rendering a plurality of depth images based on a plurality of different viewpoints from low-precision three-dimensional data; and
performing learning processing of a neural network that generates high-precision three-dimensional data from a two-dimensional image, based on the plurality of depth images.

2. The learning method according to claim 1, wherein the learning processing includes learning a three-dimensional representation by the neural network.

3. The learning method according to claim 2, wherein the three-dimensional representation by the neural network includes implicit function representation.

4. The learning method according to claim 3, wherein the learning processing includes learning Radiance Fields.

5. The learning method according to claim 4, comprising:
further rendering a plurality of the two-dimensional images based on the plurality of viewpoints from the low-precision three-dimensional data; and
performing the learning processing based on the plurality of depth images and the plurality of two-dimensional images.

6. The learning method according to claim 5, comprising: learning an implicit function so as to minimize an error, in the Radiance Fields, between an integral value of density of an object corresponding to the plurality of viewpoints and the plurality of depth images.

7. The learning method according to claim 6, comprising: learning the implicit function so as to further minimize an error between rendering images corresponding to the plurality of viewpoints obtained by volume rendering using the Radiance Fields and the plurality of two-dimensional images.

8. The learning method according to claim 1, comprising: rendering the plurality of depth images from the low-precision three-dimensional data based on a viewpoint specified by a user.

9. The learning method according to claim 1, comprising: fine-tuning the neural network by using an object image obtained by capturing a real object corresponding to the high-precision three-dimensional data.

10. The learning method according to claim 9, comprising: fine-tuning the neural network based on an error between a viewpoint image for any viewpoint obtained by inference using the neural network and the object image corresponding to the viewpoint.

11. The learning method according to claim 10, wherein the viewpoint image is the two-dimensional image for a viewpoint specified by a user.

12. The learning method according to claim 1, wherein the low-precision three-dimensional data includes three-dimensional map data.

13. An information processing device comprising:
a rendering unit that renders a plurality of depth images based on a plurality of different viewpoints from low-precision three-dimensional data; and
a learning processing unit that performs learning processing of a neural network that generates high-precision three-dimensional data from a two-dimensional image, based on the plurality of depth images.

14. A computer-readable recording medium having recorded thereon a program for executing processing of:
rendering a plurality of depth images based on a plurality of different viewpoints from low-precision three-dimensional data; and
performing learning processing of a neural network that generates high-precision three-dimensional data from a two-dimensional image, based on the plurality of depth images.
